(19) United States
(12) Patent Application Publication
(10) Pub. No.: US 2018/0213376 A1
(43) Pub. Date: Jul. 26, 2018

(54) TECHNIQUES TO CONFIGURE VEHICLE TO ANYTHING COMMUNICATIONS

(71) Applicant: INTEL CORPORATION, SANTA CLARA, CA (US)

(72) Inventors: ANA LUCIA PINHEIRO, HILLSBORO, OR (US); DAVE CAVALCANTI, BEAVERTON, OR (US)

(73) Assignee: INTEL CORPORATION, SANTA CLARA, CA (US)

(21) Appl. No.: 15/745,009

(22) PCT Filed: Apr. 1, 2016
(86) PCT No.: PCT/US2016/025704

§ 371 Date: Jan. 15, 2018

Related U.S. Application Data
(60) Provisional application No. 62/191,770, filed on Jul. 13, 2015.

(51) Int. Cl. H04W 4/44; H04W 4/46; H04W 4/06; H04W 76/14; H04W 76/11; H04W 72/00; H04W 72/04

(52) U.S. Cl. CPC H04W 4/44; H04W 4/46; H04W 4/06; H04W 72/0406; H04W 76/11; H04W 72/005; H04W 76/14

(57) ABSTRACT

Embodiments may be generally directed to determining one or more vehicle to anything (V2X) parameters for communicating subsequent V2X communications, generating a message comprising one or more V2X parameters, and communicating the message to at least one other device for use in communicating the subsequent V2X communications.

### RELATED CASE

This application claims priority to U.S. Provisional Patent Application No. 62/191,770, filed Jul. 13, 2015, the entirety of which is hereby incorporated by reference.

### TECHNICAL FIELD

Embodiments herein generally relate to communications between devices in broadband wireless communications networks.

### BACKGROUND

Vehicle-to-Anything (V2X) refers to an intelligent transport system that enables vehicles and infrastructure system to communicate data and information. The information passed in a V2X system may play a host to a number of applications including safety, mobility, and environmental applications. For example, V2X connectivity provides a more precise situational awareness across road networks with respect to optimizing traffic flows, reducing congestion, cutting accident numbers, minimizing emissions, and so forth.

### BRIEF DESCRIPTION OF THE DRAWINGS

FIG. 1A illustrates an embodiment of a first operating environment.

FIG. 1B illustrates an embodiment of a first device.

FIG. 2 illustrates an embodiment of a second operating environment.

FIG. 3 illustrates an embodiment of a third operating environment.

FIG. 4 illustrates an embodiment of a first configuration process.

FIG. 5 illustrates an embodiment of a second configuration process.

FIG. 6 illustrates an embodiment of a third configuration process.

FIG. 7A illustrates an embodiment of a message format to communicate parameters.

FIG. 7B illustrates an embodiment of a second message format to communicate parameters.

FIG. 8 illustrates an embodiment of a storage medium.

FIG. 9 illustrates an embodiment of a second device.

FIG. 10 illustrates an embodiment of a third device.

FIG. 11 illustrates an embodiment of a wireless network.

### DETAILED DESCRIPTION

Intelligent Transportation Systems (ITS) enabled by connected vehicles can improve safety and efficiency in roadways. The Wireless Access in Vehicular Environments (WAVE) architecture and standards have been developed to support ITS safety and non-safety applications. The WAVE standards are based on IEEE 802.11p, aka Dedicated Short Range Communications (DSRC), to support V2X communications, which include Vehicle-to-Vehicle (V2V), Vehicle-to-Infrastructure (V2I) and Vehicle-to-Pedestrian (V2P) communications.

Previous studies demonstrated that Long-Term Evolution's (LTE) downlink capacity limits its ability for handling permanent broadcasting for legacy ITS systems, such as Cooperative Awareness Messages (CAM) at 10 Hertz (Hz). For example, it was observed that for a 5 Mega-Hertz (MHz) spectrum, only 10 vehicles per cell can receive the CAM data sent by 40 neighboring vehicles transmitting simultaneously at a 100 millisecond (ms) latency. Thus, a slower transmission rate at 2 Hz and/or a lesser number of broadcasting vehicles is more capacity friendly.

In order to optimize air interface resource utilization and avoid congestion scenarios, the network may implement additional functionality which can be used to better configure the V2X operations. For instance, devices, such as road side units (RSU) in a busy intersection, may have a more comprehensive view of the surrounding environment than each individual vehicle. The RSUs use various sensors to detect the amount of traffic, the average speed of the vehicles, existence of pedestrians, existence of accidents, and so forth. Thus, the RSUs can use its environment awareness capability to better coordinate the frequency or message transmission rates that the vehicles transmit V2X communications. The same holds true for other devices, such as radio access network (RAN) nodes, user equipment (UE), content provider systems, and so forth. These and other details will become more apparent in the following description.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), and/or 3GPP LTE-Advanced (LTE-A) technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.11p, dedicated short range communications (DSRC), International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally or alternatively involve wireless communications according to other wireless communications technologies and/or standards. Examples of other wireless communications technologies and/or standards that may be used in various embodiments may include, without limitation, other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, and/or IEEE 802.11ah, IEEE 802.11p standards, High-Efficiency Wi-Fi standards developed by the IEEE 802.11 High Efficiency WLAN (HEW) Study Group, Wi-Fi Alliance (WFA) wireless communication standards such as Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any revisions, progeny, and/or variants of any of the above. The embodiments are not limited to these examples.

In addition to transmission over one or more wireless connections, the techniques disclosed herein may involve transmission of content over one or more wired connections through one or more wired communications media. Examples of wired communications media may include a wire, cable, metal leads, printed circuit board (PCB), backplane, switch fabric, semiconductor material, twisted-pair wire, co-axial cable, fiber optics, and so forth. The embodiments are not limited in this context.

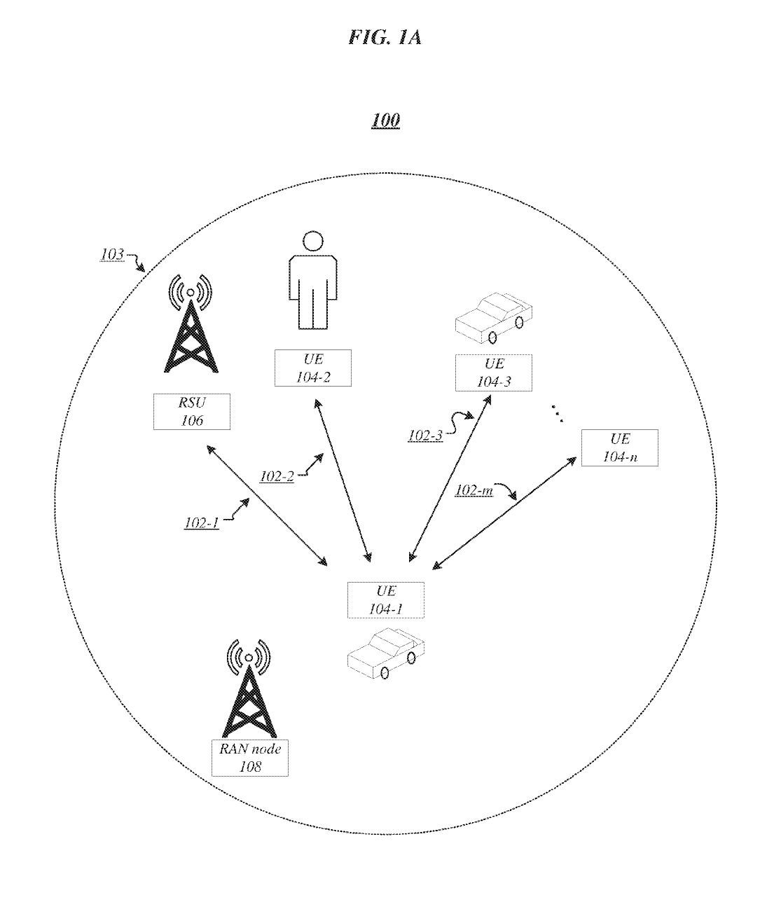

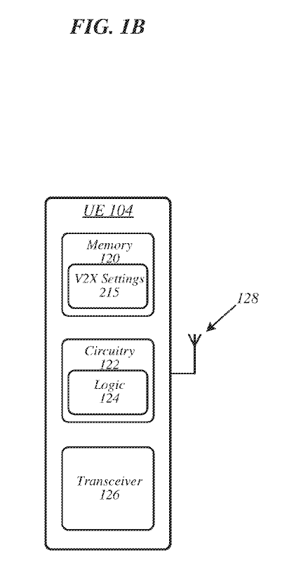

FIG. 1A illustrates an example of an operating environment 100 that may be representative of various embodiments. Operating environment 100 may include any number of user equipment (UE) 104-n, where n may be any positive integer, and a road side unit (RSU) 106. In some embodiments, the RSU 106 may be a stationary UE or an evolved node B (eNB). Note that embodiments may include more than one RSU 106, which may be implemented in other devices, such as a traffic light, light pole, signs, trash cans, and so forth.

The operating environment 100 may also include a radio access network (RAN) node 108, which may be an eNB that is capable of serving a cell 103. The RAN node 108 may provide the UE 104-n and RSU 106 with wireless connectivity via a wireless carrier of cell 103, for example. During ongoing operation, the RAN node 108 may identify and coordinate data to be transmitted to UE 104-n and RSU 106. The RAN node 108 is generally a fixed station that communicates with the UEs 104-n and RSU 106 and may be referred to as another terminology, such as a base station (BS), an access point, etc. As will be discussed in more detail below, the RAN node 108 may communicate information to the UE 104-n and RSU 106 to coordinate vehicle to anything (V2X) communications between the devices.

In some embodiments, the operating environment 100 may be an intelligent transportation system that enables V2X communications that can improve safety and efficiency along roadways, for example. The V2X communications may enable vehicles having UEs 104-n to communicate with each other and RSUs 106. The V2X communications may include vehicle information, traffic information, location information, road condition information, road obstacle information, emergency vehicle information, intersection information, and so forth.

In some embodiments, the UEs 104-n and RSU 106 may communicate V2X communications via the one or more communication links 102-m, where m may be any positive integer. The V2X communications may include V2V communications via a V2V application, V2P communications via a V2P application, and V2I communications via a V2I application. In one example embodiment, the V2V and V2P communications may be communicated between UEs 104-n and the V2I communications may be communicated between a UE 104 and a RSU 106. Embodiments are not limited in this manner.

Legacy system architectures communicating vehicle communications were typically developed with different requirements in mind such as public safety, e.g. voice communication between first responders, and consumer applications, e.g. advertisements, location information, social network, etc. These legacy systems typically communicate messages at a specified transmission rate, such as 10 hertz (Hz). Therefore, the legacy systems are not sufficiently scalable to efficiently meet the requirements of V2X communications in terms of latency and a number of vehicles supported.

Some legacy systems permit the adjustment of a repetition rate of communication by a decentralized congestion control procedure in a station or UE. This procedure is used to minimize potential congestion and is decentralized because each station makes its own decision without input from other devices or the network. However, in these decentralized systems older information in transmission queues may be discarded during times of heavy congestion. Thus, embodiments are directed to adapting a transmission rate and enable congestion control in a more centralized fashion, e.g. via a RAN node 108.

For example, in order to optimize air interface resource utilization and avoid congestion scenarios, the network or devices, such as a RAN node 108, a UE 104-n and RSU 106, may implement additional functionality which can be used to better configure the V2X operations and communications. For example, one or more devices may include one or more sensors to form a comprehensive view of the surrounding environment. The devices using various sensors can gather environmental information, such as the amount of traffic (vehicle and communication) in a cell, the average speed of the vehicles in a cell, existence of pedestrians in a cell, existence of accidents in a cell, and so forth. Thus, the devices have an extensive environment awareness capability and may communicate this information to another device, such as a RAN node 108, to be used to better coordinate the message transmission rates used by UEs 104 and RSUs 106 to communicate V2X communications and data. Note, in some instances, environmental information may be gather by multiple devices, to provide an even more comprehensive view of the surrounding environment to communicate to a RAN node 108. Embodiments are not limited in this manner.

For example, a RAN node 108 may receive environmental information from one or more other devices, and use the environmental information to determine V2X parameters. For example, a RAN node 108 may determine a message transmission rate for subsequent V2X communications based on these environmental characteristics. The message transmission rate may be a frequency at which V2X communications are communicated by UEs 104 and RSUs 106 within the operating environment 100, for example.

In some embodiments, a RAN node 108 may determine V2X parameters based on other information, such as cellular information including latency requirements for the V2X communications. For example, the latency requirement may be a specified maximum amount of time between transmission of the V2X communications, e.g. 1000 milliseconds (ms), 100 ms, 10, ms, etc. In some embodiments, the latency requirement may directly correspond with the frequency or message transmission rate at which the V2X communications are communicated. Thus, a RAN Node 108 may use this latency requirement information to determine the message transmission rate and the V2X parameters for a V2X communication.

Other cellular information may include a cell load for a cell and a number of UEs 104 and RSUs 106 in a cell using V2X services and may also be used to determine the V2X parameters. Embodiments are not limited in this manner In one example, a message transmission rate may be set at a lower frequency in a high vehicle traffic area and at higher frequency in a low vehicle traffic area. Similarly, the message transmission rate may be set at a lower frequency in a high communications traffic area and at higher frequency in a low communications traffic area, which may be based on the vehicle traffic and/or a number of pedestrians. In another example, the message transmission rate may be set at a higher frequency when the existence of one or more accidents are detected compared to when no accidents are detected.

In some embodiments, a RAN node 108 may communicate the V2X parameters in a message to one or more devices, e.g. UEs 104 and RSUs 106. For example, the RAN node 108 may send a radio resource control (RRC) message including V2X parameters using RRC signaling to one or more other devices. In this example, the V2X parameters may be communicated in a System Information Block (SIB) on a broadcast channel In another example, the RAN node 108 may include the V2X parameters in a message sent directly to one or more other devices using multicasting or unicasting. In some embodiments, the RAN node 108 may utilize a service such as Multimedia Broadcast Multicast Service (MBMS) to communicate the V2X parameters via broadcasting or multicasting. In a third example, the RAN node 108 may communicate the V2X parameters to one or more other devices in a media access control (MAC) header of a MAC protocol data unit (PDU) using MAC signaling. Embodiments are not limited in this manner.

The V2X parameters may be used by the receiving devices to configure V2X settings for communicating subsequent V2X communications. The V2X parameters may include a message-periodicity for 3GPP technologies and non-3GPP technologies, a PSID, and other V2X parameters. The other V2X parameters specified may include, but are not limited to, a type of transport protocol (IP versus non-IP), a type of resource allocation method, carrier information, a type of transmission technology (DSRC versus 3GPP), and so forth. The embodiments are not limited in this context.

FIG. 1B illustrates an example of a UE 104 for communicating V2X communications. The UE 104 including a number of components and circuitry is capable of storing, processing and communicating information and data. The UE 104 includes memory 120, circuitry 122 including logic 124, and a transceiver 126.

In embodiments, the memory 120 may be any type of memory capable storing information and data. For example, the memory 120 may store temporary variables and instructions, such as logic 124 that may be processed by circuitry 122. The memory 120 may be one or more of random access memory (RAM), read-only memory (ROM), electrically erasable programmable read-only memory (EEPROM), flash memory, and so forth. The memory 120 is not limited to these memory components. For example, the memory 120 may include a non-transitory computer-readable storage medium. In some embodiments, the memory 120 may be volatile or non-volatile memory.

In some embodiments, the memory 120 may store data, such as the V2X settings 215 that may be used to communicate the V2X communications. The V2X settings 215 may include settings for one or more V2X communications via one or more communication links and may be based on V2X parameters. The V2X settings 215 can include a message transmission rate, a PSID, and other settings for each V2X communications established between the UE 104 and one or more other devices, as previously discussed. Note that each V2X communications may have different V2X settings 215 based on the requirements of the V2X communications, resources available, environmental factors, cellular information, and so forth.

The UE 104 may also include circuitry 122 which may implement and process logic 124, e.g. one or more instructions. The circuitry 122 may be part of a processor, processing component, computer processing unit, and so forth. The circuitry 122 can process information and instructions for the UE 104, such as those implemented as logic 124. The circuitry 122 may be circuitry that carries out the instructions of a computer program by performing the basic arithmetic, logical, control and input/output (I/O) operations specified by the instructions. For example, the circuitry 122 can include an arithmetic logic unit (ALU) that performs arithmetic and logic operations. The circuitry 122 may also include a control unit that fetches instructions from memory, such as memory 120, and “executes” them by directing the coordinated operations of the ALU, registers and other components. Embodiments are not limited in this manner and the above-description only provides a high-level overview of processing by the circuitry 122.

In embodiments, the UE 104 may also include a transceiver 126 coupled with an antenna 128. The transceiver 128 can include one or more radios capable of transmitting and receiving signals using various suitable wireless communications techniques in accordance with one or more standards, as previously discussed above. Embodiments are not limited in this manner.

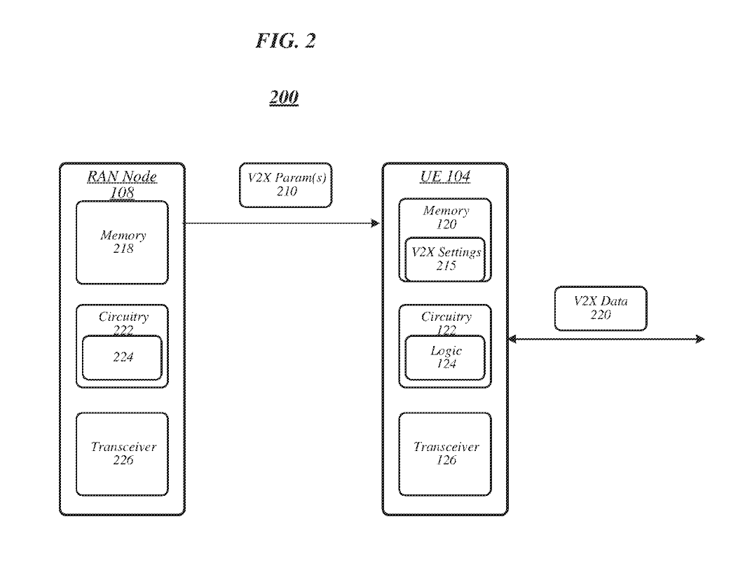

FIG. 2 illustrates an example of an operating environment 200 that may be representative of the implementation of one or more of the disclosed V2X parameter communication techniques to configure one or more devices to communicate subsequent V2X communications. In some instances, the operating environment 200 may include a RAN node 108 and a UE 104. Note that embodiments are not limited in this manner and an operating environment typically includes any number of UEs 104 which are capable of receiving the V2X parameters to conduct V2X communications. In some instances, the V2X parameters may also be received by one or more RSUs, which are configured in a similar manner as discussed herein. Embodiments may also include more than one RAN node and operating environments are not so limited.

The RAN node 108 may include memory 218 and circuitry 222 implementing and including logic 224. The RAN node 108 may also include a transceiver 226 for determining and communicating V2X parameters 210, for example. The RAN node 108 may be capable of processing and communicating information, such as information related to V2X communications.

In operation, a RAN node 108 may receive an indication of V2X communications or a desire to communicate subsequent V2X communications from another device. In addition, the RAN node 108 may receive environmental information and cellular information, such as a type of traffic for the V2X communication, an amount of communication traffic in a communication area or cell, an amount of vehicle traffic in a communication area or cell, an average speed of vehicles in a communication area or cell, existence of pedestrians in a communication area or cell, existence of accidents in the communication area or cell, latency requirements for the V2X communications and so forth. The RAN node 108 may determine to change one or more V2X settings 215 for subsequent V2X communications based on the environmental information and/or cellular information.

More specifically, the RAN node 108 may determine the V2X parameters based on the environmental information and cellular information and communicate the V2X parameters 210 in a message (or messages) to UE 104 (and other UEs 104 and/or RSUs 106) to cause the UE 104 to configure V2X settings 215 for subsequent V2X communications to communicate V2X data 220. The V2X parameters 210 may specify a message transmission rate and a PSID for the V2X communication. In some instances, the actual message transmission rate and PSID may be communicated in a message to the UE 104. In other instances, the message transmission rate and PSID may be communicated as one or more values that may be used by the UE 104 to determine the actual message transmission rate and/or the PSID for the V2X communication. For example, a message-periodicity integer value associated with a message transmission rate may be communicated in a message to the UE 104. The UE 104 may receive the message including the message-periodicity integer value and determine the appropriate message transmission rate based on a lookup in a table, for example. In another example, a string value identifying the PSID may be communicated in a message to the UE 104. The string value may be the actual PSID or information that may be used by the UE 104 to lookup the PSID, in a table, for example. As will be discussed in more detail below, the same message may include the message-periodicity integer value for the message transmission rate and the string value for the PSID. Embodiments are not limited in this manner.

In some instances, the V2X parameters 210 may include information for V2X communications communicated utilizing 3GPP technologies and non-3GPP technologies, such as Dedicated Short Range Communications (DSRC). For example, a message may include the message-periodicity integer value associated with a message transmission rate for V2X communications utilizing 3GPP technologies. The same or different message may include a message-periodicity-DSRC integer value associated with a message transmission rate for V2X communications utilizing non-3GPP technologies. Embodiments are not limited in this manner and other technologies may be added to the message as appropriate.

In some embodiments, the RAN node 108 may communicate the V2X parameters 210 in a broadcast message over a broadcast channel More specifically, the V2X parameters 210 may be included in a new or existing SIB communicated to the UE 104 over the broadcast channel using RRC signaling. The SIB including the V2X parameters 210 may be communicated as a broadcast message to the UE 104 and any other devices, such as other UEs and RSUs that are in range to receive the broadcast. The UE 104 may receive and process the V2X parameters 210 to set the V2X settings 215. Once configured, the UE 104 may conduct V2X communication in accordance with the V2X settings 215 to communicate V2X data 220 with devices, such as other UEs and RSUs.

In some embodiments, the RAN node 108 may communicate the V2X parameters 210 using dedicated messages to the UE 104 using RRC signaling. For example, the RAN node 108 may send the V2X parameters 210 to the UE 104 directly in a message, using multicast addressing or unicast addressing. As similarly discussed, above the V2X parameters 210 may include a message transmission rate and PSID for a subsequent V2X communication between the UE 104 and other devices. In embodiments, the RAN node 108 communicating and utilizing the dedicated messages may configure and set different V2X settings 215 with different UEs 104. For example, the RAN node 108 may communicate first V2X parameters 210 directly to the UE 104 to establish V2X settings for the UE 104. The UE 104 may receive the V2X parameters 210, process the V2X parameters 210, and set the V2X settings 215 based on the V2X parameters 210 to conduct V2X operations with at least one other device. The RAN node 108 may establish a different V2X communications for another device, such as another UE or RSU, by communicating a different dedicated message having different (or same) V2X parameters to the device. The device may receive the different V2X parameters and set different V2X settings to communicate V2X communications. Any number of V2X communications may be established between devices which may have the same or different V2X settings based on the same or different V2X parameters. Embodiments are not limited in this manner.

In some embodiments, the RAN node 108 may communicate V2X parameters 210 to the UE 104 in a MAC header of a MAC PDU. In some instances, the V2X parameters 210 may be communicated on a broadcast channel or multicast channel in a MAC header of a MAC PDU using MAC signaling, for example. In some embodiments, the RAN node 108 may receive a message including the V2X parameters 210 or information indicating desired settings for a V2X communications from another UE or UE 104. The RAN node 108 may generate or add a MAC header at the MAC layer including the V2X parameters 210 for use in a subsequent V2X communications. More specifically, the RAN node 108 may broadcast or multicast the MAC

PDU with the MAC header including the V2X parameters 210 to the UE 104 and devices within range, such as other UEs and RSUs, for use in subsequent V2X communications. Thus, all or at least of some of the other devices may communicate V2X communications based on the V2X parameters 210 received in the MAC header of the MAC PDU. For example, the UE 104 in operating environment 200 may receive the V2X parameters 210 in a MAC header of the MAC PDU from the RAN node 108, process the V2X parameters 210, and set the V2X settings 215 for subsequent V2X communications with one or more other devices including the originate UE 104. Embodiments are not limited in this manner and other devices may perform similar operations.

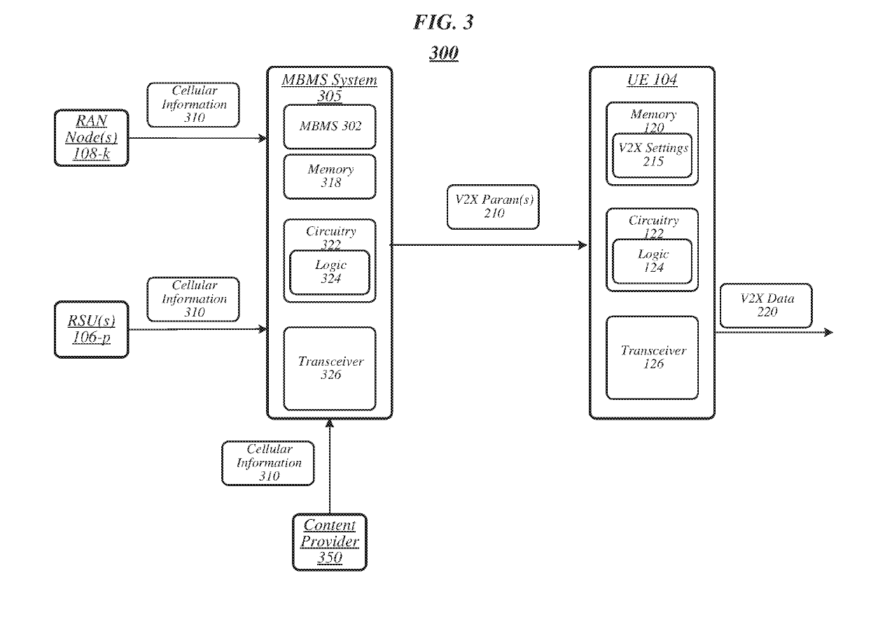

FIG. 3 illustrates an example of an operating environment 300 that may be representative of the implementation of one or more of the disclosed V2X parameter communication techniques to configure one or more devices to communicate subsequent V2X communications. In one or more embodiments, an MBMS system 305 providing channels to support a Multimedia Broadcast Multicast Service (MBMS) 302 may be utilized to configure UEs and RSUs for V2X communications, for example. The MBMS 302 may be a functional entity and provide services via a Broadcast Multicast Service Centre (BM-SC) including a MBMS bearer service and a MBMS user service, a MBMS Gateway (GW), a mobility management entity (MME), and so forth. Note that the MBMS system 305 may include one or more compute devices, such as nodes, to provide the MBMS services.

In some embodiments, MBMS system 305 may receive cellular information 310 which may include cellular measurements sent by any number of other RAN nodes 108-k, e.g. eNB, and RSUs 106-p, via a MBMS GW, for example. In this illustrated embodiments, the MBMS system 305 may use the cellular information 310 to generate V2X parameters 210 to configure devices to communicate V2X communications. In some instances, the MBMS system 305 may receive cellular information from a content provider 350, such as an Intelligent Transportation System (ITS) content provider, for use in generating the V2X parameters 210. Embodiments, are not limited in this manner.

The cellular measurements may include a cellular load for a communication area or cell, a number of devices utilize V2X services for a communication area or cell, and a latency requirement for the subsequent V2X communications. Further, the cellular load may be a measurement of amount of communication traffic in a cell at specific a point in time or an average value of amount of communication traffic over a specified time frame. The number of devices may include the number of UEs and RSUs communicating within a cell and the latency requirement may be a maximum amount of time between transmissions for V2X communications.

In some embodiments, the MBMS system 305 may determine whether the current V2X settings support V2X communication in accordance with the received cellular information 310. If the current V2X settings support the requirements, the MBMS system 305 may not communicate new V2X parameters 210 to change the V2X settings 215. However, if the current V2X settings for devices do not support the requirements specified in the cellular information 310 or the V2X settings 215 cannot be determined, the MBMS system 305 may communicate V2X parameters 210 to adjust V2X settings 215 for receiving devices. For example, the MBMS system 305 may broadcast or multicast the V2X parameters 210 using the services provided by the MBMS 302 to one or more UEs 104 and/or RSUs 106. In some embodiments, the MBMS system 305 may communicate the V2X parameters 210 to devices utilizing 3GPP technology and/or non-3GPP technology. Note, the MBMS system 305 may determine V2X parameters 210 for communications based on the cellular information 310, and in some instances other information, such as environmental information which may receive from RAN nodes 108-k, RSUs 106-p, and a content provider 350.

In some instances, the one or more of the RAN nodes 108-k may determine the V2X parameters 210 and communicate them to UEs 104 and RSUs 106 via the MBMS system 305 providing communications services, e.g. a multicast service and a broadcast service. In other words, the MBMS system 305 may operate as a communication service provider to communicate messages and information between the RAN nodes 108-k, RSUs 106-p, the content provider 350, and other devices, such as UE 104, to provide V2X parameters 210 to one or more other devices. For example, a content provider 350, and/or one or more RSUs 106-p may provide information, such as cellular information 310, environmental information, and so forth, to one or more RAN nodes 108-k, via the MBMS system 305. The RAN nodes 108-k may receive and use this information to determine V2X parameters 210 which may be communicated other device, such as UE 104, via the MBMS system 305.

The UEs and RSUs receiving the V2X parameters 210, such as UE 104 may process the V2X parameters 210 and generate V2X settings 215 for subsequent V2X communications. The UEs and RSUs may then perform the subsequent V2X communications to communicate V2X data 220 between each other, for example.

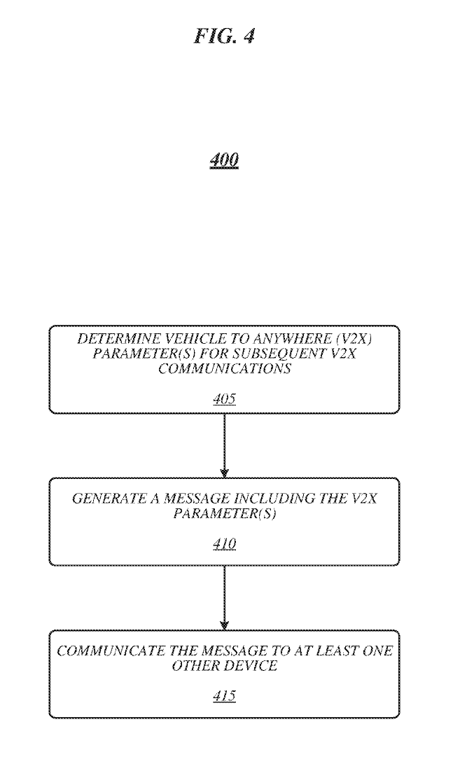

FIG. 4 illustrates an example of a first configuration process 400 that may be representative of some embodiments discussed herein. For example, the configuration process 400 may illustrate operations performed by a RAN node 108. However, embodiments are not limited in this manner and one or more operations discussed below may be performed by other devices, such as a UE 104 or a RSU 106.

At block 405, the configuration process 400 may include determining V2X parameters for subsequent V2X communications. For example, the V2X parameters may be based on environmental information, such as an amount of vehicle traffic, an average speed of vehicles, existence of pedestrians, existence of accidents, and so forth. The environmental information may be determined/detected by one or more sensors (not shown) that may be implemented in a UE, a RSU, an eNB, and so forth, for example. In some instances, the information may be measured and/or calculated by a component of other one or more devices and communicated to the determining device. Embodiments are not limited in this manner.

In some embodiments, the V2X parameters may also be based on cellular information, such as a cellular load, a number of devices utilizing V2X services, and a latency requirement for the subsequent V2X communications. In one example using the cellular load, a message transmission rate may be lower when the cellular load is high (above a load threshold value) and higher when the cellular load is low (below a load threshold value). The threshold value may be predetermined and/or set by a user of the system. In some instances, the message transmission rate may be inversely proportional to the cellular load. Embodiments are not limited in this manner and a similar determination may be made using a number of devices utilizing V2X services, e.g. the message transmission rate may be lower when there are higher number of devices and higher when there are lower number of devices.

In another example, a latency requirement may be used to determine the V2X parameters. For example, Cooperative Adaptive Cruise Control (CACC), V2I/V2N Traffic Flow Optimization, and Curve Speed Warning require 1000 ms latency. Road safety service via infrastructure require 500 ms latency. While autonomous driving has very strict requirements of 1 ms latency. The UEs and RSUs may communicate V2X communications less frequently or at lower message transmission rates for traffic having a less strict latency requirement than traffic having more strict latency requirements. More specifically, the message transmission rate may be lower for CACC communications than for road safety service communications and autonomous drive communications. In another example, the message transmission rate may be higher for road safety service communications than CACC communications but lower than the message transmission rate for autonomous drive communications. Embodiments are not limited to these examples and other environmental and cellular characteristics may be used to determine the V2X parameters.

The configuration process 400 may also include generating a message including the V2X parameters at block 410. As previously discussed, the V2X parameters may be in message using a new or existing SIB. In another example, the V2X parameters may be including in a message for direct communication to another device. In a third example, the V2X parameters may be included in a MAC header of a MAC PDU. Embodiments are not limited in this manner.

Further and at block 415, the configuration process 400 may include communicating the message to at least one other device. As previously mentioned, the message may be communicated via broadcasting, multicasting, or unicasting. For example, a message including a new or existing SIB may be communicated via a broadcast channel using RRC signaling. In another example, a direct message may be communicated via multicasting or unicasting to another device using RRC signaling. In a third example, the V2X parameters may be communicated in the MAC PDU in a broadcast, multicast, or unicast communication via MAC signaling. Embodiments are not limited in this manner.

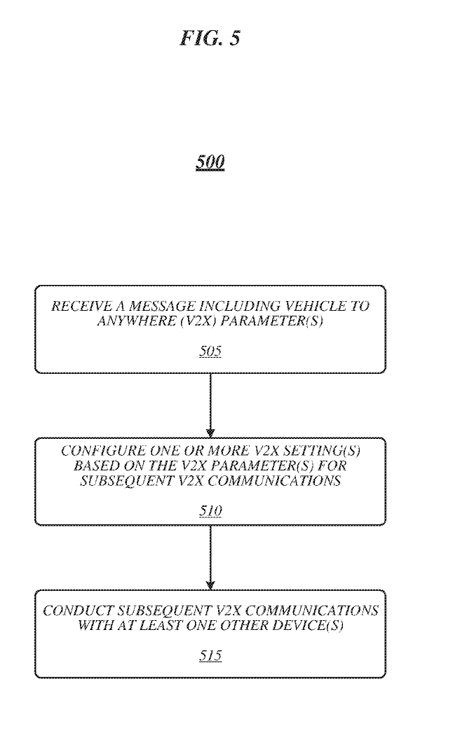

FIG. 5 illustrates an example of a second configuration process 500 that may be representative of some embodiments discussed herein. For example, the configuration process 500 may illustrate operations performed by a UE 104, a RSU 106, or another device.

At block 505, the configuration process 500 may include receiving a message including V2X parameters. The V2X parameters, may include a message transmission rate for communicating over a 3GPP network, a message transmission rate for communicating over a non 3GPP network, such as DSRC, a PSID for a network, and one or more other V2X parameters. The V2X parameters may be received in a broadcast, multicast, or unicast message communicated from another device, such as a RAN node 108 or in some instances a RSU 106. Further, the message may include a new or existing SIB having the V2X parameters, a MAC PDU having the V2X parameters in a MAC header, and/or may be a direct message. Embodiments are not limited in this manner.

The configuration process 500 also includes configuring one or more V2X settings based on the V2X parameters for subsequent V2X communications. More specifically, the V2X parameters may be communicated as values that may need to be processed by the receiving device to determine the V2X parameters. For example, a message transmission rate may be communicated as a message-periodicity integer value, such as an integer value between one and ten (1-10). The integer value may be converted into a frequency value, e.g. an integer value of one may convert to one hertz (Hz). Thus, in some instances, the integer value may be the frequency value. However, in some instances, integer value may not directly correspond with the frequency value. For example, the integer value may be from 1 to 20 and the frequency may be from 1 Hz to 10 Hz. Thus, even (or odd) integer values may represent′ Hz based on the starting value. Embodiments are not limited in this manner.

In addition, the V2X parameters may include the PSID as a PSID string value that may be used to set the V2X settings to communicate the V2X communications with the correct PSID. For example, the PSID string value may represent an abbreviation or some other representation corresponding to a PSID. Embodiments are not limited in this manner.

In some embodiments, the V2X parameters may include parameters for non-3GPP communications. For example, the V2X parameters may include a message-periodicity-DSRC integer value corresponding with a message transmission rate for V2X communications using non-3GPP radio technologies. As similarly discussed above, the integer value for the message-periodicity-DSRC may be used in a similar manner as discussed above with respect to the message-periodicity integer value.

At block 515, the configuration process 500 may include conducting the subsequent communications with at least one other device. For example, one or more UEs and/or RSUs may send and receive one or messages having V2X data with one or more other UEs and/or RSUs. The V2X data may include vehicle information, traffic information, location information, road condition information, road obstacle information, emergency vehicle information, intersection information, and so forth.

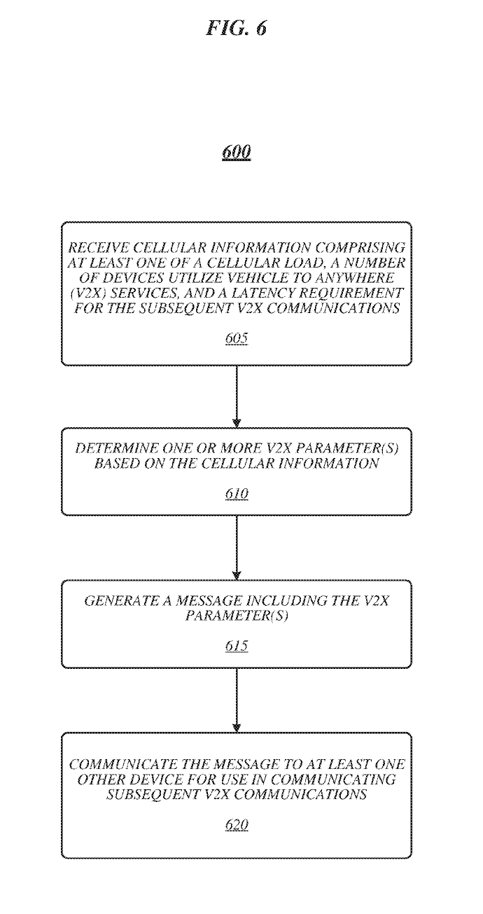

FIG. 6 illustrates an example of a third configuration process 600 that may be representative of some embodiments discussed herein. For example, the configuration process 600 may illustrate operations performed by a MBMS system 305 providing services such as MBMS 302.

At block 605, the configuration process 600 may include receiving cellular information including at least one of a cellular load, a number of devices utilizing V2X services, and a latency requirement for a subsequent V2X communication. The cellular load may be a measurement of amount of communication traffic in a cell at a specific a point in time or an average value of amount of communication traffic over a specified time frame. The number of devices may include the number of UEs and/or RSUs communicating within a cell and the latency requirement may be a maximum amount of time between transmissions for V2X communications. In some instances, the latency requirement may be based on the type of communication for the subsequent V2X communications. Note that the cellular information may be received from one or more RAN nodes, RSUs, and/or a content provider for example, or determined by a RAN node itself.

In some embodiments, the configuration process 600 may include determining one or more V2X parameters based on the cellular information at block 610. For example, embodiments may include setting a message transmission rate for V2X communications based on a cellular load, a number of devices utilizing V2X services, and a latency requirement. In some instances, embodiments may include determining the V2X parameters based on environmental information in addition to the cellular information. Embodiments are not limited in this manner.

The configuration process 600 may also include generating a message including the V2X parameters at block 615. As previously discussed, the V2X parameters may be in a message having new or existing SIB. In another example, the V2X parameters may be including in a message for direct communication to another device. In a third example, the V2X parameters may be included in a MAC header of a MAC PDU. Embodiments are not limited in this manner.

Further and at block 620, the configuration process 600 may include communicating the message to at least one other device. As previously mentioned, the message may be communicated via broadcasting, multicasting, or unicasting. For example, a message including a new or existing SIB may be communicated via a broadcast channel. In another example, a direct message may be communicated via multicasting or unicasting. In a third example, the V2X parameters may be communicated in a MAC PDU in a broadcast, multicast, or unicast communication. Embodiments are not limited in this manner.

In some embodiments, one or more devices, such as UEs and/or RSUs, may receive the V2X parameters, process the V2X parameters and configure V2X settings for subsequent V2X communications, as previous discussed above in FIG. 5, for example. The devices may communicate V2X communications including V2X data based on the V2X parameters. Embodiments are not limited in this manner.

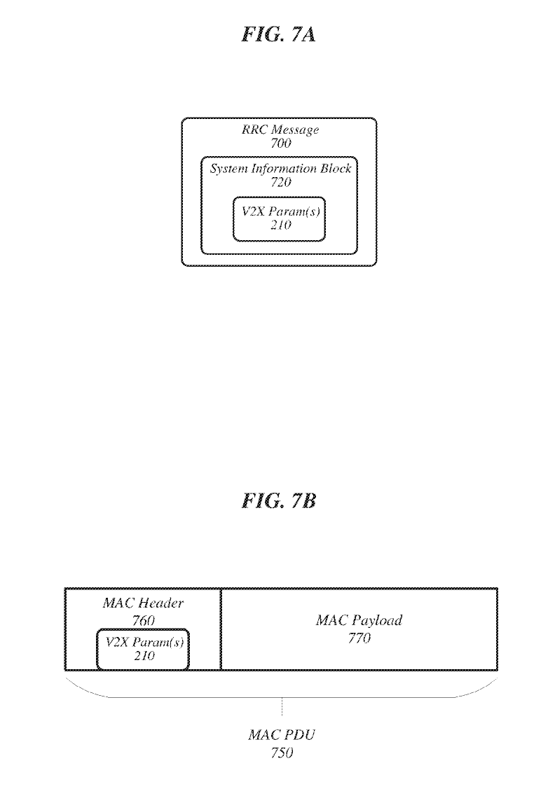

FIGS. 7A/7B illustrate example message formats 700 and 750 that may include V2X parameters 210 for communication to another device to configure V2X communications. More specifically, FIG. 7A illustrates a radio resource control (RRC) message 700 having a SIB 720 with the V2X parameters 210. In some embodiments the SIB 720 may be a new SIB or existing SIB defined in one or more specifications, such as 3GPP TS 36.331.

In an example embodiment, an information element (IE) SystemInformationBlockTypeX may be used to communicate the V2X parameters, as shown below:

TABLE 1
SystemInformationBlockTypeX IE

-- ASN1START

| | |
|---|---|
| SystemInformationBlockTypeX : : = | SEQUENCE { |
| message-periodicity | INTEGER (1 . . 10)) |
| . . . , | |
| lateNonCriticalExtension | OCTET STRING OPTIONAL |
| } | |
| -- ASN1STOP | |

SystemInformationBlockTypeX field descriptions
message-periodicity
Contains the maximum allowed periodicity for 3GPP communications.

Further and as defined in table 1, the message-periodicity may be an integer value between 1 and 10, and used to determine a message transmission rate for communicating subsequent V2X communications. For example, an integer value of 10 may correspond with 10 Hz and an integer value of 1 may correspond with 1 Hz. Embodiments are not limited in this manner, as previously discussed.

In another example, the network may be able to also define the message periodicity for other non-3GPP radio technologies. Below is an example of the SIB with DSRC and LTE message periodicity defined. The SIB in this example may apply for UEs that support LTE and DSRC or other non-3GPP technologies. These other technologies can be added as appropriate.

TABLE 2
SystemInformationBlockTypeX information element

-- ASN1START

| | |
|---|---|
| SystemInformationBlockTypeX : : = | SEQUENCE { |
| message-periodicity | INTEGER (1 . . 10)) |
| message-periodicity-DSRC | INTEGER (1 . . 10)) |
| . . . , | |
| lateNonCriticalExtension | OCTET STRING OPTIONAL |
| } | |
| -- ASN1STOP | |

SystemInformationBlockTypeX field descriptions
message-periodicity
Contains the maximum allowed periodicity for 3GPP communications.
message-periodicity-DSRC
Contains the maximum allowed periodicity for non-3GPP communications.

Note that the message-periodicity may be an integer value between 1 and 10, and used to determine a message transmission rate for communicating subsequent V2X communications via 3GPP technologies. Similarly, the message-periodicity-DSRC may include the maximum allowed periodicity for non-3GPP communications. The message-periodicity-DSRC may be also an integer value between 1 and 10, and used to determine a message transmission rate for communicating subsequent V2X communications. Note that embodiments are not limited to these integer values and other values may be used as message periodicity parameters.

In a third example, other fields can be added to one of the above SIBs, as shown below.

TABLE 3
SystemInformationBlockTypeX information element

-- ASN1START

| | |
|---|---|
| SystemInformationBlockTypeX : : = | SEQUENCE { |
| message-periodicity | INTEGER (1 . . 10)) |
| PSID | OCTET STRING (SIZE(4)) OPTIONAL |
| . . . , | |
| lateNonCriticalExtension | OCTET STRING OPTIONAL |
| } | |
| -- ASN1STOP | |

SystemInformationBlockTypeX field descriptions
message-periodicity
Contains the maximum allowed periodicity for 3GPP communications.
PSID
The PSID (Provider Service Identifier) identifies an application service that uses the V2X
communication. The PSID value can be used by a V2X proximity services (ProSe) function to
determine the type of communication services the V2X UE is authorized to use.

As discussed in table 3, the message-periodicity may include the maximum allowed periodicity for 3GPP communications. Further the PSID identifies an application service that uses the V2X communication. The PSID value can be used by a V2X ProSe function to determine the type of communication services the V2X UE is authorized to use. Note that other fields may be added to the SIB for communication with other devices. Embodiments are not limited to these example SIBs. For example, other SIBs may be defined based other fields to be included as V2X parameters.

FIG. 7B illustrates a MAC PDU 750 having a MAC header 760 and a MAC Payload 770. The MAC header 760 may include the V2X parameters 210 and a number of MAC sub-headers (not shown). In some embodiments, a MAC sub-header may include the V2X parameters 210. The MAC header 760 may also include a number of other fields not illustrated, such as a logic channel ID (LCID) field, a length field, a format field, and an extension field. Embodiments are not limited in this manner.

As previously discussed, the V2X parameters 210 may be added to the MAC header 760 at the MAC layer by a device, such as an eNB, a RAN node, or RSU. In some instances, the MAC header 760 may be added to one or more messages generated by another device, such as a UE, and added by the RAN node, eNB or RSU to be broadcasted or multicasted within a cell or communication area. Embodiments are not limited in this manner.

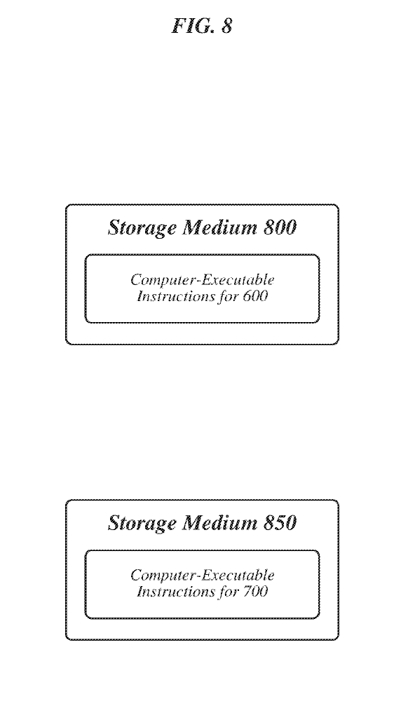

FIG. 8 illustrates an embodiment of a storage medium 800 and an embodiment of a storage medium 850. Storage media 800 and 850 may comprise any non-transitory computer-readable storage media or machine-readable storage media, such as an optical, magnetic or semiconductor storage media. In various embodiments, storage media 800 and 850 may comprise an article of manufacture. In some embodiments, storage media 800 and 850 may store computer-executable instructions, such as computer-executable instructions to implement logic flows 400, 500, and 600, respectively. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

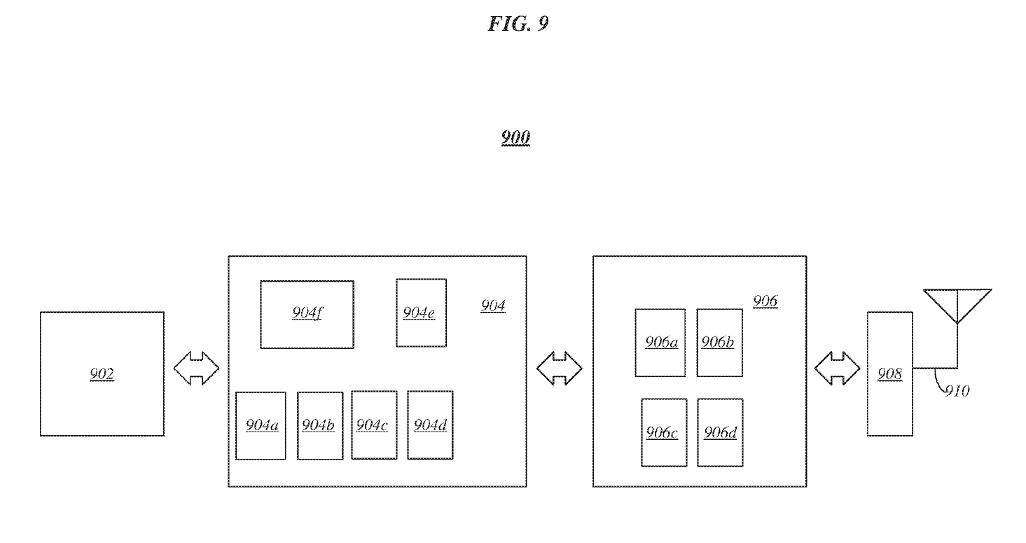

FIG. 9 illustrates an example of a UE device 900 that may be representative of a UE that implements one or more of the disclosed techniques in various embodiments. For example, UE device 900 may be representative of UE 104 according to some embodiments. In some embodiments, the UE device 900 may include application circuitry 902, baseband circuitry 904, Radio Frequency (RF) circuitry 906, front-end module (FEM) circuitry 908 and one or more antennas 910, coupled together at least as shown.

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 904 may include circuitry such as, but not limited to, one or more single-core or multi-core processors. The baseband circuitry 904 may include one or more baseband processors and/or control logic to process baseband signals received from a receive signal path of the RF circuitry 906 and to generate baseband signals for a transmit signal path of the RF circuitry 906. Baseband processing circuitry 904 may interface with the application circuitry 902 for generation and processing of the baseband signals and for controlling operations of the RF circuitry 906. For example, in some embodiments, the baseband circuitry 904 may include a second generation (2G) baseband processor 904a, third generation (3G) baseband processor 904b, fourth generation (4G) baseband processor 904c, and/or other baseband processor(s) 904d for other existing generations, generations in development or to be developed in the future (e.g., fifth generation (5G), 6G, etc.). The baseband circuitry 904 (e.g., one or more of baseband processors 904a-d) may handle various radio control functions that enable communication with one or more radio networks via the RF circuitry 906. The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), preceding, and/or constellation mapping/demapping functionality. In some embodiments, encoding/decoding circuitry of the baseband circuitry 904 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 904e of the baseband circuitry 904 may be configured to run elements of the protocol stack for signaling of the PHY, MAC, RLC, PDCP and/or RRC layers. In some embodiments, the baseband circuitry may include one or more audio digital signal processor(s) (DSP) 904f. The audio DSP(s) 904f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 904 is configured to support radio communications of more than one wireless protocol may be referred to as multi-mode baseband circuitry.

RF circuitry 906 may enable communication with wireless networks using modulated electromagnetic radiation through a non-solid medium. In various embodiments, the RF circuitry 906 may include switches, filters, amplifiers, etc. to facilitate the communication with the wireless network. RF circuitry 906 may include a receive signal path which may include circuitry to down-convert RF signals received from the FEM circuitry 908 and provide baseband signals to the baseband circuitry 904. RF circuitry 906 may also include a transmit signal path which may include circuitry to up-convert baseband signals provided by the baseband circuitry 904 and provide RF output signals to the FEM circuitry 908 for transmission.

In some embodiments, the RF circuitry 906 may include a receive signal path and a transmit signal path. The receive signal path of the RF circuitry 906 may include mixer circuitry 906a, amplifier circuitry 906b and filter circuitry 906c. The transmit signal path of the RF circuitry 906 may include filter circuitry 906c and mixer circuitry 906a. RF circuitry 906 may also include synthesizer circuitry 906d for synthesizing a frequency for use by the mixer circuitry 906a of the receive signal path and the transmit signal path. In some embodiments, the mixer circuitry 906a of the receive signal path may be configured to down-convert RF signals received from the FEM circuitry 908 based on the synthesized frequency provided by synthesizer circuitry 906d. The amplifier circuitry 906b may be configured to amplify the down-converted signals and the filter circuitry 906c may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, mixer circuitry 906a of the receive signal path may comprise passive mixers, although the scope of the embodiments is not limited in this respect.

In some embodiments, the mixer circuitry 906a of the transmit signal path may be configured to up-convert input baseband signals based on the synthesized frequency provided by the synthesizer circuitry 906d to generate RF output signals for the FEM circuitry 908. The baseband signals may be provided by the baseband circuitry 904 and may be filtered by filter circuitry 906c. The filter circuitry 906c may include a low-pass filter (LPF), although the scope of the embodiments is not limited in this respect.

In some embodiments, the mixer circuitry 906a of the receive signal path and the mixer circuitry 906a of the transmit signal path may include two or more mixers and may be arranged for quadrature downconversion and/or upconversion respectively. In some embodiments, the mixer circuitry 906a of the receive signal path and the mixer circuitry 906a of the transmit signal path may include two or more mixers and may be arranged for image rejection (e.g., Hartley image rejection). In some embodiments, the mixer circuitry 906a of the receive signal path and the mixer circuitry 906a may be arranged for direct downconversion and/or direct upconversion, respectively. In some embodiments, the mixer circuitry 906a of the receive signal path and the mixer circuitry 906a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 906 may include analog-to-digital converter (ADC) and digital-to-analog converter (DAC) circuitry and the baseband circuitry 904 may include a digital baseband interface to communicate with the RF circuitry 906.

In some dual-mode embodiments, a separate radio IC circuitry may be provided for processing signals for each spectrum, although the scope of the embodiments is not limited in this respect.

In some embodiments, the synthesizer circuitry 906d may be a fractional-N synthesizer or a fractional N/N+1 synthesizer, although the scope of the embodiments is not limited in this respect as other types of frequency synthesizers may be suitable. For example, synthesizer circuitry 906d may be a delta-sigma synthesizer, a frequency multiplier, or a synthesizer comprising a phase-locked loop with a frequency divider.

The synthesizer circuitry 906d may be configured to synthesize an output frequency for use by the mixer circuitry 906a of the RF circuitry 906 based on a frequency input and a divider control input. In some embodiments, the synthesizer circuitry 906d may be a fractional N/N+1 synthesizer.

In some embodiments, frequency input may be provided by a voltage controlled oscillator (VCO), although that is not a requirement. Divider control input may be provided by either the baseband circuitry 904 or the applications processor 902 depending on the desired output frequency. In some embodiments, a divider control input (e.g., N) may be determined from a look-up table based on a channel indicated by the applications processor 902.

Synthesizer circuitry 906d of the RF circuitry 906 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 906d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 906 may include an IQ/polar converter.

FEM circuitry 908 may include a receive signal path which may include circuitry configured to operate on RF signals received from one or more antennas 910, amplify the received signals and provide the amplified versions of the received signals to the RF circuitry 906 for further processing. FEM circuitry 908 may also include a transmit signal path which may include circuitry configured to amplify signals for transmission provided by the RF circuitry 906 for transmission by one or more of the one or more antennas 910.

In some embodiments, the FEM circuitry 908 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 906). The transmit signal path of the FEM circuitry 908 may include a power amplifier (PA) to amplify input RF signals (e.g., provided by RF circuitry 906), and one or more filters to generate RF signals for subsequent transmission (e.g., by one or more of the one or more antennas 910.

In some embodiments, the UE device 900 may include additional elements such as, for example, memory/storage, display, camera, sensor, and/or input/output (I/O) interface.

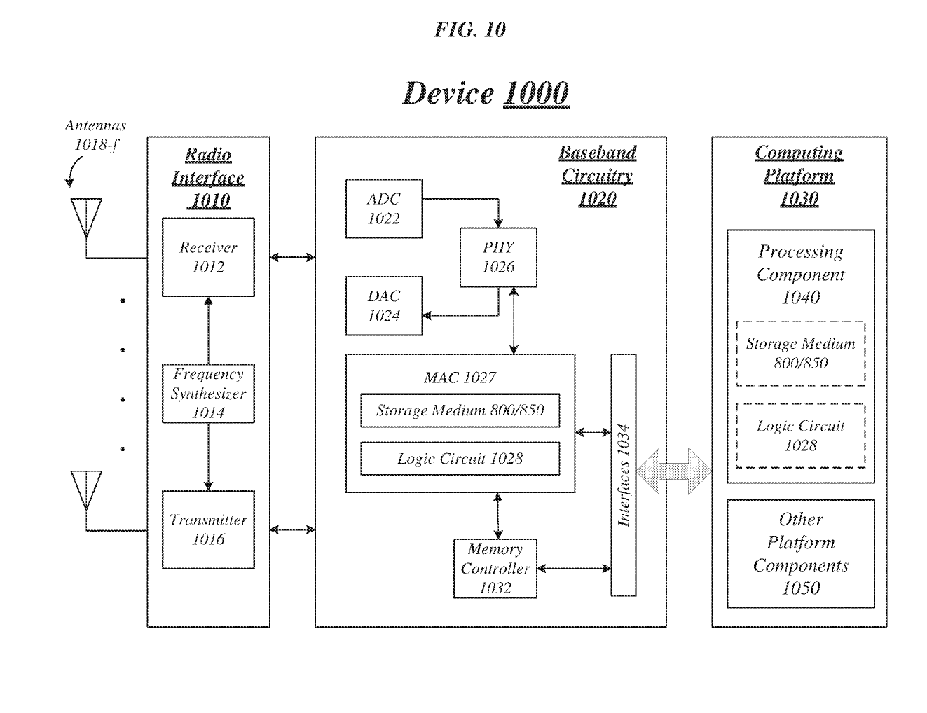

FIG. 10 illustrates an embodiment of a communications device 1000 that may implement one or more of UE 104, RSU 106, processing flows 400, 500, and 600, storage medium 800, storage medium 850, and UE 900. In various embodiments, device 1000 may comprise a logic circuit 1028. The logic circuit 1028 may include physical circuits to perform operations described for one or more of UE 104, RSU 106, processing flows 400, 500, and 600, and UE 900 of FIG. 9 for example. As shown in FIG. 10, device 1000 may include a radio interface 1010, baseband circuitry 1020, and computing platform 1030, although the embodiments are not limited to this configuration.

The device 1000 may implement some or all of the structure and/or operations for one or more of UE 104, RSU 106, processing flows 400, 500, and 600, storage medium 800, storage medium 850, UE 900, and logic circuit 1028 in a single computing entity, such as entirely within a single device. Alternatively, the device 1000 may distribute portions of the structure and/or operations for one or more of UE 104, RSU 106, processing flows 400, 500, and 600, storage medium 800, storage medium 850, UE 900, and logic circuit 1028 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1010 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 1010 may include, for example, a receiver 1012, a frequency synthesizer 1014, and/or a transmitter 1016. Radio interface 1010 may include bias controls, a crystal oscillator and/or one or more antennas 1018-f. In another embodiment, radio interface 1010 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1020 may communicate with radio interface 1010 to process receive and/or transmit signals and may include, for example, a mixer for down-converting received RF signals, an analog-to-digital converter 1022 for converting analog signals to digital form, a digital-to-analog converter 1024 for converting digital signals to analog form, and a mixer for up-converting signals for transmission. Further, baseband circuitry 1020 may include a baseband or physical layer (PHY) processing circuit 1026 for PHY link layer processing of respective receive/transmit signals. Baseband circuitry 1020 may include, for example, a medium access control (MAC) processing circuit 1027 for MAC/data link layer processing. Baseband circuitry 1020 may include a memory controller 1032 for communicating with MAC processing circuit 1027 and/or a computing platform 1030, for example, via one or more interfaces 1034.

In some embodiments, PHY processing circuit 1026 may include a frame construction and/or detection module, in combination with additional circuitry such as a buffer memory, to construct and/or deconstruct communication frames. Alternatively or in addition, MAC processing circuit 1027 may share processing for certain of these functions or perform these processes independent of PHY processing circuit 1026. In some embodiments, MAC and PHY processing may be integrated into a single circuit.

The computing platform 1030 may provide computing functionality for the device 1000. As shown, the computing platform 1030 may include a processing component 1040. In addition to, or alternatively of, the baseband circuitry 1020, the device 1000 may execute processing operations or logic for one or more of UE 104, RSU 106, processing flows 400, 500, and 600, storage medium 800, storage medium 850, UE 900, and logic circuit 1028 using the processing component 1040. The processing component 1040 (and/or PHY 1026 and/or MAC 1027) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1030 may further include other platform components 1050. Other platform components 1050 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1000 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 1000 described herein, may be included or omitted in various embodiments of device 1000, as suitably desired.

Embodiments of device 1000 may be implemented using single input single output (SISO) architectures. However, certain implementations may include multiple antennas (e.g., antennas 1018-f) for transmission and/or reception using adaptive antenna techniques for beamforming or spatial division multiple access (SDMA) and/or using MIMO communication techniques.

The components and features of device 1000 may be implemented using any combination of discrete circuitry, application specific integrated circuits (ASICs), logic gates and/or single chip architectures. Further, the features of device 1000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1000 shown in the block diagram of FIG. 10 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

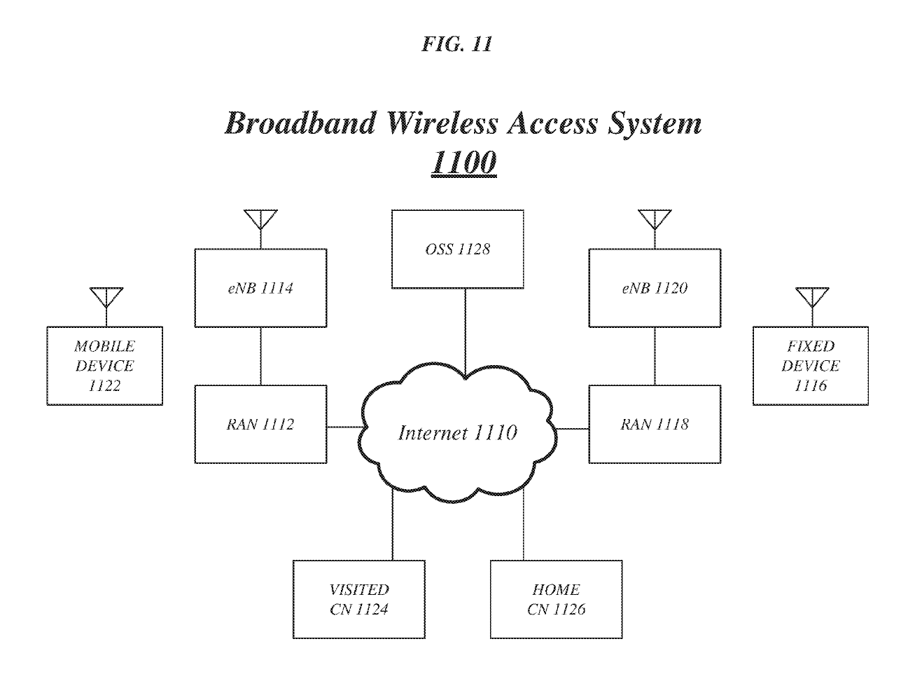

FIG. 11 illustrates an embodiment of a broadband wireless access system 1100. As shown in FIG. 11, broadband wireless access system 1100 may be an internet protocol (IP) type network comprising an internet 1110 type network or the like that is capable of supporting mobile wireless access and/or fixed wireless access to internet 1110. In one or more embodiments, broadband wireless access system 1100 may comprise any type of orthogonal frequency division multiple access (OFDMA)-based or single-carrier frequency division multiple access (SC-FDMA)-based wireless network, such as a system compliant with one or more of the 3GPP LTE Specifications and/or IEEE 802.16 Standards, and the scope of the claimed subject matter is not limited in these respects.

In the exemplary broadband wireless access system 1100, radio access networks (RANs) 1112 and 1118 are capable of coupling with evolved node Bs (eNBs) 1114 and 1120, respectively, to provide wireless communication between one or more fixed devices 1116 and internet 1110 and/or between or one or more mobile devices 1122 and Internet 1110. One example of a fixed device 1116 and a mobile device 1122 is device 1000 of FIG. 10, with the fixed device 1116 comprising a stationary version of device 1000 and the mobile device 1122 comprising a mobile version of device 1000. RANs 1112 and 1118 may implement profiles that are capable of defining the mapping of network functions to one or more physical entities on broadband wireless access system 1100. eNBs 1114 and 1120 may comprise radio equipment to provide RF communication with fixed device 1116 and/or mobile device 1122, such as described with reference to device 1000, and may comprise, for example, the PHY and MAC layer equipment in compliance with a 3GPP LTE Specification or an IEEE 802.16 Standard. eNBs 1114 and 1120 may further comprise an IP backplane to couple to Internet 1110 via RANs 1112 and 1118, respectively, although the scope of the claimed subject matter is not limited in these respects.

Broadband wireless access system 1100 may further comprise a visited core network (CN) 1124 and/or a home CN 1126, each of which may be capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VoIP) gateways, and/or internet protocol (IP) type server functions, or the like. However, these are merely example of the types of functions that are capable of being provided by visited CN 1124 and/or home CN 1126, and the scope of the claimed subject matter is not limited in these respects. Visited CN 1124 may be referred to as a visited CN in the case where visited CN 1124 is not part of the regular service provider of fixed device 1116 or mobile device 1122, for example where fixed device 1116 or mobile device 1122 is roaming away from its respective home CN 1126, or where broadband wireless access system 1100 is part of the regular service provider of fixed device 1116 or mobile device 1122 but where broadband wireless access system 1100 may be in another location or state that is not the main or home location of fixed device 1116 or mobile device 1122. The embodiments are not limited in this context.

Fixed device 1116 may be located anywhere within range of one or both of eNBs 1114 and 1120, such as in or near a home or business to provide home or business customer broadband access to Internet 1110 via eNBs 1114 and 1120 and RANs 1112 and 1118, respectively, and home CN 1126. It is worthy of note that although fixed device 1116 is generally disposed in a stationary location, it may be moved to different locations as needed. Mobile device 1122 may be utilized at one or more locations if mobile device 1122 is within range of one or both of eNBs 1114 and 1120, for example. In accordance with one or more embodiments, operation support system (OSS) 1128 may be part of broadband wireless access system 1100 to provide management functions for broadband wireless access system 1100 and to provide interfaces between functional entities of broadband wireless access system 1100. Broadband wireless access system 1100 of FIG. 11 is merely one type of wireless network showing a certain number of the components of broadband wireless access system 1100, and the scope of the claimed subject matter is not limited in these respects.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

Example 1 may include a method comprising: transmitting, from the network, a broadcast message to the UEs including V2X parameters; receiving and processing, in the UE, the broadcast message.

Example 2 may include the method of example 1 or some other example herein, wherein the broadcast message is sent on a System Information Broadcast (SIB) dedicated to V2X parameters.

Example 3 may include the method of example 1 or some other example herein, wherein the broadcast message is sent on an existing System Information Broadcast (SIB) message.

Example 4 may include the method of example 1 or some other example herein, wherein the V2X parameters include at least the value of the maximum allowed frequency of transmission of V2X messages.

Example 5 may include the method of example 1 or some other example herein, wherein the V2X parameters include at least the PSID (Provider Service Identifier).

Example 6 may include a method of example 4 or some other example herein, wherein the UE receiving and processing the broadcast message limits the frequency of transmission V2X messages to the maximum allowed value.

Example 7 may include a method comprising: transmitting, from the network, a broadcast message to the UEs including V2X parameters; and, optionally, wherein the V2X parameters include one or more of: maximum allowed frequency of transmission of V2X messages and PSID (Provider Service Identifier).

Example 8 may include a method comprising: transmitting, from the network, a V2X message to a set of at least one UE and including in the MAC header of the MAC PDU one or more V2X parameters; receiving and processing, in the UE, the MAC header.

Example 9 may include the method of example 8 or some other example herein, wherein the V2X parameters include at least the maximum allowed frequency of transmission of V2X messages.

Example 10 may include a method of example 9 or some other example herein, wherein the UE receiving and processing the MAC PDU limits the frequency of transmission V2X messages to the maximum allowed value.

Example 11 may include the method of example 8 or some other example herein, wherein the MAC PDU is a PDU reserved for V2X messages only.

Example 12 may include a method comprising: transmitting, from the RAN Node, cell measurements to the MBMS functional entity; receiving and processing, in the MBMS functional entity, the cell measurements; sending from the MBMS functional entity V2X parameters to be sent to at least one UE subscribed to the V2X service.

Example 13 may include the method of example 12 or some other example herein, wherein the MBMS functional entity is the Broadcast Multicast Service Centre (BM-SC) or the MBMS GW.

Example 14 may include the method of example 12 or some other example herein, wherein V2X parameters include at least the maximum message transmission rate allowed to be used by the UEs subscribed to the V2X service.

Example 15 may include a method comprising: generating, by a radio access network (RAN) node, a message that includes one or more vehicle to anything (V2X) related parameters; and broadcasting, by the RAN node, the message.

Example 16 may include the method of example 15 or some other example herein, further comprising broadcasting, by the RAN node, the message via a System Information Broadcast (SIB).

Example 17 may include the method of example 16 or some other example herein, wherein the SIB is dedicated to broadcast of V2X parameters.

Example 18 may include the method of example 15 or some other example herein, wherein the V2X parameters include at least a value related to a maximum allowed frequency of transmission of V2X messages.

Example 19 may include the method of example 15 or some other example herein, wherein the V2X parameters include at least a provider service identifier (PSID).

Example 20 may include the method of example 15 or some other example herein, wherein the RAN node is an evolved NodeB (eNB).

Example 21 may include a radio access network (RAN) node comprising: control logic to generate a message that includes one or more vehicle to anything (V2X) related parameters; and transmit logic coupled with the control logic, the transmit logic to broadcast the message.

Example 22 may include the RAN node of example 21 or some other example herein, wherein the transmit logic is further to broadcast the message via a System Information Broadcast (SIB).

Example 23 may include the RAN node of example 22 or some other example herein, wherein the SIB is dedicated to broadcast of V2X parameters.

Example 24 may include the RAN node of example 21 or some other example herein, wherein the V2X parameters include at least a value related to a maximum allowed frequency of transmission of V2X messages.

Example 25 may include the RAN node of example 21 or some other example herein, wherein the V2X parameters include at least a provider service identifier (PSID).

Example 26 may include the RAN node of example 21 or some other example herein, wherein the RAN node is an evolved NodeB (eNB).

Example 27 may include a method comprising: receiving, by a user equipment, a broadcast message that includes one or more vehicle to anything (V2X) related parameters; and performing, by the UE, a V2X procedure based on the received one or more V2X parameters.

Example 28 may include the method of example 27 or some other example herein, further comprising receiving, by the UE, the message via a System Information Broadcast (SIB).

Example 29 may include the method of example 28 or some other example herein, wherein the SIB is dedicated to broadcast of V2X parameters.

Example 30 may include the method of example 27 or some other example herein, wherein the V2X parameters include at least a value related to a maximum allowed frequency of transmission of V2X messages.

Example 31 may include the method of example 27 or some other example herein, wherein the V2X parameters include at least a provider service identifier (PSID).

Example 32 may include the method of example 27 or some other example herein, wherein the performing the V2X procedure includes limiting, by the UE, a frequency of transmission of V2X messages to a maximum allowed value based on the received one or more V2X parameters.

Example 33 may include a user equipment (UE) comprising: receive logic to receive a broadcast message that includes one or more vehicle to anything (V2X) related parameters; and control logic coupled with the receive logic, the control logic to perform a V2X procedure based on the received one or more V2X parameters.

Example 34 may include the UE of example 33 or some other example herein, wherein the receive logic is to receive the message via a System Information Broadcast (SIB).

Example 35 may include the UE of example 34 or some other example herein, wherein the SIB is dedicated to broadcast of V2X parameters.

Example 36 may include the UE of example 33 or some other example herein, wherein the V2X parameters include at least a value related to a maximum allowed frequency of transmission of V2X messages.

Example 37 may include the UE of example 33 or some other example herein, wherein the V2X parameters include at least a provider service identifier (PSID).

Example 38 may include the EU of example 33 or some other example herein, wherein the control logic is further to limit a frequency of transmission of V2X messages to a maximum allowed value based on the received one or more V2X parameters.

Example 39 may include a method comprising: generating, by a radio access network (RAN) node, a media access control (MAC) packet data unit (PDU) with a MAC header that includes one or more vehicle to anything (V2X) related parameters; and transmitting, by the RAN node, a message that includes the MAC PDU.

Example 40 may include the method of example 39 or some other example herein, wherein the one or more V2X parameters include an indication of a maximum allowed frequency of transmission of V2X messages.

Example 41 may include the method of example 39 or some other example herein, wherein the MAC PDU is a PDU reserved for V2X messages only.

Example 42 may include the method of example 39 or some other example herein, wherein the RAN node is an evolved NodeB (eNB).

Example 43 may include a radio access network (RAN) node comprising: control logic to generate a media access control (MAC) packet data unit (PDU) with a MAC header that includes one or more vehicle to anything (V2X) related parameters; and transmit logic coupled with the control logic, the transmit logic to transmit a message that includes the MAC PDU.

Example 44 may include the RAN node of example 43 or some other example herein, wherein the one or more V2X parameters include an indication of a maximum allowed frequency of transmission of V2X messages.

Example 45 may include the RAN node of example 43 or some other example herein, wherein the MAC PDU is a PDU reserved for V2X messages only.

Example 46 may include the RAN node of example 43 or some other example herein, wherein the RAN node is an evolved NodeB (eNB).

Example 47 may include a method comprising: receiving, by a user equipment (UE), a message that includes a media access control (MAC) packet data unit (PDU) with a MAC header that includes one or more vehicle to anything (V2X) related parameters; and performing, by the UE, a V2X related procedure based on the one or more V2X parameters.

Example 48 may include the method of example 47 or some other example herein, wherein the one or more V2X parameters include an indication of a maximum allowed frequency of transmission of V2X messages.

Example 49 may include the method of example 47 or some other example herein, wherein the MAC PDU is a PDU reserved for V2X messages only.

Example 50 may include the method of example 47 or some other example herein, wherein the performing the V2X related procedure includes limiting, by the UE, a frequency of transmission V2X messages to a maximum allowed value based on the one or more V2X parameters.

Example 51 may include a user equipment (UE) comprising: receive logic to receive a message that includes a media access control (MAC) packet data unit (PDU) with a MAC header that includes one or more vehicle to anything (V2X) related parameters; and control logic coupled with the receive logic, the control logic to perform a V2X related procedure based on the one or more V2X parameters.

Example 52 may include the UE of example 51 or some other example herein, wherein the one or more V2X parameters include an indication of a maximum allowed frequency of transmission of V2X messages.

Example 53 may include the UE of example 51 or some other example herein, wherein the MAC PDU is a PDU reserved for V2X messages only.

Example 54 may include the UE of example 51 or some other example herein, wherein the control logic is further to limit a frequency of transmission V2X messages to a maximum allowed value based on the one or more V2X parameters.

Example 55 may include a method comprising: transmitting, by a radio access network

(RAN) node, one or more cell measurements to a multimedia broadcast multicast service (MBMS) functional entity; receiving, by the RAN node, an indication of one or more vehicle to anything (V2X) related parameters related to a V2X service, wherein the one or more V2X parameters are based on the cell measurements; and transmitting, by the RAN node, an indication of the one or more V2X parameters to a user equipment (UE) that is subscribed to the V2X service.

Example 56 may include the method of example 55 or some other example herein, wherein the MBMS functional entity is a Broadcast Multicast Service Centre (BM-SC) or a MBMS gateway (GW).

Example 57 may include the method of example 55 or some other example herein, wherein the one or more V2X parameters include at least a maximum message transmission rate allowed to be used by a UE subscribed to the V2X service.

Example 58 may include the method of example 55 or some other example herein, wherein the RAN node is an evolved NodeB (eNB).

Example 59 may include a radio access network (RAN) node comprising: receive logic to receive an indication of one or more vehicle to anything (V2X) related parameters related to a V2X service from a multimedia broadcast multicast service (MBMS) functional entity, wherein the one or more V2X parameters are based on cell measurements by the RAN node; and transmit logic coupled with the receive logic, the transmit logic to transmit an indication of the one or more V2X parameters to a user equipment (UE) that is subscribed to the V2X service.

Example 60 may include the RAN node of example 59 or some other example herein, wherein the MBMS functional entity is a Broadcast Multicast Service Centre (BM-SC) or a MBMS gateway (GW).

Example 61 may include the RAN node of example 59 or some other example herein, wherein the one or more V2X parameters include at least a maximum message transmission rate allowed to be used by a UE subscribed to the V2X service.

Example 62 may include the RAN node of example 59 or some other example herein, wherein the RAN node is an evolved NodeB (eNB).

Example 63 may include a method comprising: receiving, by a multimedia broadcast multicast service (MBMS) functional entity, an indication of one or more cell measurements; identifying, by the MBMS functional entity based on the one or more cell measurements, one or more vehicle to anything (V2X) related parameters related to a V2X service; and transmitting, by the MBMS functional entity, an indication of the one or more V2X parameters.

Example 64 may include the method of example 63 or some other example herein, wherein the MBMS functional entity is a Broadcast Multicast Service Centre (BM-SC) or a MBMS gateway (GW).

Example 65 may include the method of example 63 or some other example herein, wherein the one or more V2X parameters include at least a maximum message transmission rate allowed to be used by a UE subscribed to the V2X service.

Example 66 may include a multimedia broadcast multicast service (MBMS) functional entity comprising: receive logic to receive an indication of one or more cell measurements; control logic coupled with the receive logic, the control logic to identify, based on the one or more cell measurements, one or more vehicle to anything (V2X) related parameters related to a V2X service; and transmit logic coupled with the receive logic, the transmit logic to transmit an indication of the one or more V2X parameters.

Example 67 may include the MBMS functional entity of example 63 or some other example herein, wherein the MBMS functional entity is a Broadcast Multicast Service Centre (BM-SC) or a MBMS gateway (GW).

Example 68 may include the MBMS functional entity of example 63 or some other example herein, wherein the one or more V2X parameters include at least a maximum message transmission rate allowed to be used by a UE subscribed to the V2X service.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
memory; and
logic, at least a portion of which is implemented in processing circuitry coupled to the memory, the logic to:
determine one or more vehicle to anything (V2X) parameters for communicating subsequent V2X communications;
generate a message comprising one or more V2X parameters; and
cause communication of the message to at least one other device for use in communicating the subsequent V2X communications.

2. The apparatus of claim 1, the logic to cause communication of the message comprising a radio resource control (RRC) message having a System Information Block (SIB) dedicated to the one or more V2X parameters via a broadcast channel.

3. The apparatus of claim 1, the logic to cause communication of the message comprising a radio resource control (RRC) message having an existing System Information Block (SIB) with the one or more V2X parameters via a broadcast channel.

4. The apparatus of claim 1, the logic to cause communication of the message comprising the one or more V2X parameters in a media access control (MAC) header of a MAC protocol data unit (PDU).

5. The apparatus of claim 1, the logic to:
receive cellular information comprising at least one of a cellular load, a number of devices utilize V2X services, and a latency requirement for the subsequent V2X communications; and
determine the one or more V2X parameters based on the cellular information for communication in the message.

6. The apparatus of claim 1, the one or more V2X parameters comprising at least one of a message-periodicity integer value and a Provider Service Identifier (PSID) string value.

7. The apparatus of claim 1, the memory and logic implemented in one of a radio access network (RAN) node, an evolved node B (eNB), and a multimedia broadcast multicast service (MBMS) functional entity system.

8. The apparatus of claim 1, comprising:
an antenna coupled with the memory and the processing circuitry; and
a transceiver coupled with the antenna, the memory and the processing circuitry, the transceiver to cause communication of the message.

9. A non-transitory computer-readable storage medium comprising a plurality of instructions that when executed enable processing circuitry to:
determine one or more vehicle to anything (V2X) parameters for communicating subsequent V2X communications;
generate a message comprising one or more V2X parameters; and
cause communication of the message to at least one other device for use in communicating the subsequent V2X communications.

10. The non-transitory computer-readable storage medium of claim 9, comprising the plurality of instructions that when executed enable the processing circuitry to cause communication of the message comprising a radio resource control (RRC) message having a System Information Block (SIB) dedicated to the one or more V2X parameters via a broadcast channel.

11. The non-transitory computer-readable storage medium of claim 9, comprising the plurality of instructions that when executed enable the processing circuitry to cause communication of the message comprising radio resource control (RRC) message using an existing System Information Block (SIB) with the one or more V2X parameters via a broadcast channel.

12. The non-transitory computer-readable storage medium of claim 9, comprising the plurality of instructions that when executed enable the processing circuitry to cause communication of the message comprising the one or more V2X parameters in a media access control (MAC) header of a MAC protocol data unit (PDU).

13. The non-transitory computer-readable storage medium of claim 9, comprising the plurality of instructions that when executed enable the processing circuitry to:
receive cellular information about a cellular network, the cellular information comprising at least one of a cellular load, a number of devices utilize V2X services, and a latency requirement for the subsequent V2X communications; and
determine the one or more V2X parameters based on the cellular information for communication in the message.

14. The non-transitory computer-readable storage medium of claim 9, the one or more V2X parameters comprising at least one of a message-periodicity integer value and a Provider Service Identifier (PSID) string value.

15. An apparatus, comprising:
memory; and
logic, at least a portion of which is implemented in processing circuitry coupled to the memory, the logic to:
receive a message comprising one or more vehicle to anything (V2X) parameters;
configure V2X settings based on the one or more V2X parameters for use in communicating subsequent V2X communications, the V2X settings comprising at least a message transmission rate for the subsequent V2X communications; and
conduct the subsequent V2X communications based on the V2X settings.

16. The apparatus of claim 15, the logic to receive the message comprising a radio resource control (RRC) message having a System Information Block (SIB) dedicated to the one or more V2X parameters via a broadcast channel.

17. The apparatus of claim 15, the logic to receive the message comprising a radio resource control (RRC) message using an existing System Information Block (SIB) with the one or more V2X parameters via a broadcast channel.

18. The apparatus of claim 15, the logic to receive the message comprising the one or more V2X parameters in a media access control (MAC) header of a MAC protocol data unit (PDU).

19. The apparatus of claim 15, the one or more V2X parameters comprising at least one of a message transmission rate value and a Provider Service Identifier (PSID) value.

20. The apparatus of claim 15, the memory and logic implemented in one of a user equipment (UE), a radio access network (RAN) node, evolved node B (eNB), and road side unit (RSU).

21. A non-transitory computer-readable storage medium comprising a plurality of instructions that when executed enable processing circuitry to:
receive a message comprising one or more vehicle to anything (V2X) parameters;
configure V2X settings based on the one or more V2X parameters for use in communicating subsequent V2X communications, the V2X settings comprising at least a message transmission rate for the subsequent V2X communications; and
conduct the subsequent V2X communications based on the V2X settings.

22. The non-transitory computer-readable storage medium of claim 21, comprising the plurality of instructions that when executed enable the processing circuitry to receive the message comprising a radio resource control (RRC) message having a System Information Block (SIB) dedicated to the one or more V2X parameters via a broadcast channel.

23. The non-transitory computer-readable storage medium of claim 21, comprising the plurality of instructions that when executed enable the processing circuitry to receive the message comprising a radio resource control (RRC) message having an existing System Information Block (SIB) with the one or more V2X parameters via a broadcast channel.

24. The non-transitory computer-readable storage medium of claim 21, comprising the plurality of instructions that when executed enable the processing circuitry to receive the message comprising the one or more V2X parameters in a media access control (MAC) header of a MAC protocol data unit (PDU).

25. The non-transitory computer-readable storage medium of claim 21, the one or more V2X parameters comprising at least one of a message-periodicity integer value and a Provider Service Identifier (PSID) string value.
